(19) United States
(12) Patent Application Publication
(10) Pub. No.: US 2026/0247312 A1
(43) Pub. Date: Aug. 20, 2026

(54) ARTIFICIALLY MANIPULATING DELAY IN RADIO ACCESS NETWORKS AND DISTRIBUTED ANTENNA SYSTEMS

(71) Applicant: Outdoor Wireless Networks LLC, Richardson, TX (US)

(72) Inventor: Van Erick Hanson, Forest, VA (US)

(73) Assignee: Outdoor Wireless Networks LLC, Richardson, TX (US)

(21) Appl. No.: 19/471,049

(22) PCT Filed: Mar. 8, 2024
(86) PCT No.: PCT/US2024/019028

§ 371 Date: Sep. 30, 2025

Related U.S. Application Data
(60) Provisional application No. 63/493,461, filed on Mar. 31, 2023.

(51) Int. Cl. H04W 56/00; H04B 17/364; H04L 43/0852; H04W 88/08

(52) U.S. Cl. CPC H04W 56/004; H04B 17/364; H04L 43/0852; H04W 88/085

(57) ABSTRACT

Embodiments are directed to compensating for increased signal propagation delay in a distributed antenna system. The distributed antenna system is configured to determine an apparent delay based on a delay variable. A distributed unit or other radio access network node uses the apparent delay instead of the actual delay to determine other delays between signal paths between the radio access network node and the distributed antenna system. Because the radio access network node overcalculates the delays between the signal paths that couple the radio access network node to the distributed antenna system, the distributed antenna system can underreport delays from the distributed antenna system that are within a maximum delay threshold.

### CROSS-REFERENCE TO RELATED APPLICATIONS

This application claims priority to U.S. Provisional Application Ser. No. 63/493,461, filed on Mar. 31, 2023, and titled “ARTIFICIALLY MANIPULATING DELAY IN RADIO ACCESS NETWORKS AND DISTRIBUTED ANTENNA SYSTEMS,” the contents of which are incorporated herein in its entirety.

### BACKGROUND

A distributed antenna system (DAS) typically includes one or more master units that are communicatively coupled to a plurality of remotely located access points or antenna units (also referred to here as “radio units”), where each access point can be coupled directly to one or more of the master units or indirectly via one or more other remote units and/or via one or more intermediary or expansion units or nodes. A DAS is typically used to improve the coverage provided by one or more base stations that are coupled to the central access nodes. These base stations can be coupled to the one or more master units via one or more cables or via a wireless connection, for example, using one or more donor antennas. The wireless service provided by the base stations can include commercial cellular service and/or private or public safety wireless communications. A DAS is typically utilized by multiple carriers providing wireless service, in which each carrier provides wireless signals in one or more coverage areas supported by the DAS.

A DAS may be coupled to a radio access network (RAN) in order to extend the wireless coverage provided by the RAN.

### SUMMARY

The details of one or more embodiments are set forth in the description below. The features illustrated or described in connection with one exemplary embodiment may be combined with the features of other embodiments. Thus, any of the various embodiments described herein can be combined to provide further embodiments.

Aspects of the embodiments can be modified, if necessary to employ concepts of any patents, applications and publications as identified herein to provide yet further embodiments.

In one embodiment, a method for compensating excessive time delay due to signal propagation in a distributed antenna system is disclosed. The distributed antenna system comprises at least one master unit coupled to a plurality of radio units. Each radio unit of the plurality of radio units is coupled to at least one antenna. The at least one master unit is coupled to at least one radio access network (RAN) node. The method comprises determining a loopback processing delay based on a delay variable in response to a received query message from the at least one RAN node. The method comprises sending a first message to the at least one RAN node including an apparent loopback processing delay. The apparent loopback processing delay is less than the loopback processing delay. The method comprises determining at least one signal path time delay of one or more signal paths of the distributed antenna system. The at least one signal path time delay corresponds to a period of time in which a signal propagates from one point of the one or more signal paths to a second point of the one or more signal paths. The method comprises determining at least one apparent signal path time delay of the one or more signal paths based on the delay variable and the respective at least one signal path time delay. The method comprises sending a second message to the at least one RAN node that includes the at least one apparent signal path time delay.

In another embodiment, a distributed antenna system is disclosed. The distributed antenna system comprises at least one master unit communicatively coupled to at least one radio access network (RAN) node. The distributed antenna system comprises a plurality of radio units communicatively coupled to the at least one master unit. Each radio unit of the plurality of radio units is coupled to at least one antenna. The at least one master unit is configured to determine a loopback processing delay based on a delay variable in response to a received query message from the at least one RAN node. The at least one master unit is configured to send a first message to the at least one RAN node including an apparent loopback processing delay. The apparent loopback processing delay is less than the loopback processing delay. The at least one master unit is configured to determine at least one signal path time delay of one or more signal paths of the distributed antenna system. The at least one signal path time delay corresponds to a period of time in which a signal propagates from one point of the one or more signal paths to a second point of the one or more signal paths. The at least one master unit is configured to determine at least one apparent signal path time delay of the one or more signal paths based on the delay variable and the respective at least one signal path time delay. The at least one master unit is configured to send a second message to the at least one RAN node that includes the at least one apparent signal path time delay.

In yet another embodiment, a system is disclosed. The system comprises at least one first unit communicatively coupled to at least one radio access network (RAN) node. The system comprises a plurality of second units communicatively coupled to the at least one first unit via one or more signal paths. The at least one first unit comprises at least one processor. The at least one processor is configured to determine a loopback processing delay based on a delay variable in response to a received query message from the at least one RAN node. The at least one processor is configured to send a first message to the at least one RAN node including an apparent loopback processing delay. The apparent loopback processing delay is less than the loopback processing delay. The at least one processor is configured to determine at least one signal path time delay of the one or more signal paths. The at least one signal path time delay corresponds to a period of time in which a signal propagates from one point of the one or more signal paths to a second point of the one or more signal paths. The at least one processor is configured to determine at least one apparent signal path time delay of the one or more signal paths based on the delay variable. The at least one processor is configured to send a second message to the at least one RAN node that includes the at least one apparent signal path time delay.

Other embodiments are further disclosed, as subsequently described.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, as briefly summarized below and as described further in conjunction with the detailed description.

FIGS. 1-4 depict block diagrams of exemplary systems configured to provide wireless service to user equipment.

FIG. 5 depicts a block diagram of a radio access network including a distributed unit coupled to a radio unit, as described in one or more embodiments.

FIGS. 6A-6B depict block diagrams of systems including a distributed unit coupled to a distributed antenna system, as described in one or more embodiments.

FIG. 7 depicts a block diagram of a distributed antenna system including a master unit, an intermediate combining node, and a radio unit, as described in one or more embodiments.

FIG. 8 depicts a flow diagram of a method for compensating excessive time delay due to signal propagation in a system coupled to a RAN, as described in one or more embodiments.

FIG. 9 depicts a flow diagram illustrating an example of the functions described in FIGS. 1-8 as applied to a RAN node and a DAS, as described in one or more embodiments.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, any methods presented in the drawing figures and the specification is not to be construed as limiting the order in which the individual steps may be performed. The following detailed description is, therefore, not to be taken in a limiting sense.

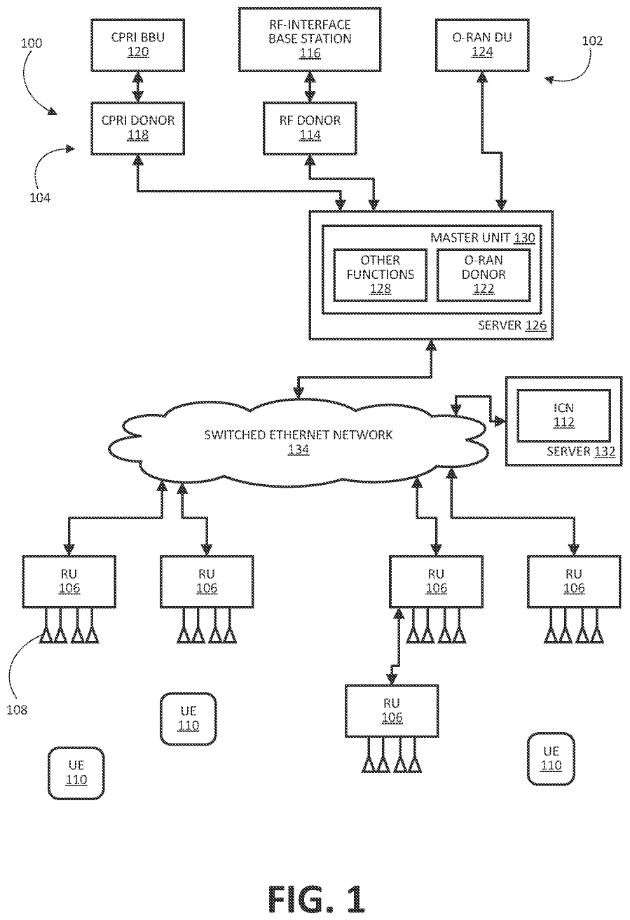

FIG. 1 is a block diagram illustrating an exemplary embodiment of a distributed antenna system (DAS) 100 that is configured to serve one or more base stations 102. In the exemplary embodiment shown in FIG. 1, the DAS 100 includes one or more donor units 104 that are used to couple the DAS 100 to the base stations 102. The DAS 100 also includes a plurality of remotely located radio units (RUs) 106 (also referred to as “antenna units,” “access points,” “remote units,” or “remote antenna units”). The RUs 106 are communicatively coupled to the donor units 104.

Each RU 106 includes, or is otherwise associated with, a respective set of coverage antennas 108 via which downlink analog RF signals can be radiated to user equipment (UEs) 110 and via which uplink analog RF signals transmitted by UEs 110 can be received. The DAS 100 is configured to serve each base station 102 using a respective subset of RUs 106 (which may include less than all of the RUs 106 of the DAS 100). Also, the subsets of RUs 106 used to serve the base stations 102 may differ from base station 102 to base station 102. The subset of RUs points 106 used to serve a given base station 102 is also referred to here as the “simulcast zone” for that base station 102. In general, the wireless coverage of a base station 102 served by the DAS 100 is improved by radiating a set of downlink RF signals for that base station 102 from the coverage antennas 108 associated with the multiple RUs 106 in that base station's stations simulcast zone and by producing a single “combined” set of uplink base station signals or data that is provided to that base station 102. The single combined set of uplink base station signals or data is produced by a combining or summing process that uses inputs derived from the uplink RF signals received via the coverage antennas 108 associated with the RUs 106 in that base station's simulcast zone.

The DAS 100 can also include one or more intermediary combining nodes (ICNs) 112 (also referred to as “expansion” units or nodes). For each base station 102 served by a given ICN 112, the ICN 112 is configured to receive a set of uplink transport data for that base station 102 from a group of “southbound” entities (that is, from RUs 106 and/or other ICNs 112) and generate a single set of combined uplink transport data for that base station 102, which the ICN 112 transmits “northbound” towards the donor unit 104 serving that base station 102. The single set of combined uplink transport data for each served base station 102 is produced by a combining or summing process that uses inputs derived from the uplink RF signals received via the coverage antennas 108 of any southbound RUs 106 included in that base station's simulcast zone. As used here, “southbound” refers to traveling in a direction “away,” or being relatively “farther,” from the donor units 104 and base stations 102, and “northbound” refers to traveling in a direction “towards”, or being relatively “closer” to, the donor units 104 and base stations 102.

In some configurations, each ICN 112 also forwards downlink transport data to the group of southbound RUs 106 and/or ICNs 112 served by that ICN 112. Generally, ICNs 112 can be used to increase the number of RUs 106 that can be served by the donor units 104 while reducing the processing and bandwidth load relative to having the additional RUs 106 communicate directly with each such donor unit 104.

Also, one or more RUs 106 can be configured in a “daisy-chain” or “ring” configuration in which transport data for at least some of those RUs 106 is communicated via at least one other RU 106. Each RU 106 would also perform the combining or summing process for any base station 102 that is served by that RU 106 and one or more of the southbound entities subtended from that RU 106. (Such a RU 106 also forwards northbound all other uplink transport data received from its southbound entities.)

The DAS 100 can include various types of donor units 104. One example of a donor unit 104 is an RF donor unit 114 that is configured to couple the DAS 100 to a base station 116 using the external analog radio frequency (RF) interface of the base station 116 that would otherwise be used to couple the base station 116 to one or more antennas (if the DAS 100 were not being used). This type of base station 116 is also referred to here as an “RF-interface” base station 116. An RF-interface base station 116 can be coupled to a corresponding RF donor unit 114 by coupling each antenna port of the base station 116 to a corresponding port of the RF donor unit 114.

Each RF donor unit 114 serves as an interface between each served RF-interface base station 116 and the rest of the DAS 100 and receives downlink base station signals from, and outputs uplink base station signals to, each served RF-interface base station 116. Each RF donor unit 114 performs at least some of the conversion processing necessary to convert the base station signals to and from the digital fronthaul interface format natively used in the DAS 100 for communicating time-domain baseband data. The downlink and uplink base station signals communicated between the RF-interface base station 116 and the donor unit 114 are analog RF signals. Also, in this example, the digital fronthaul interface format natively used in the DAS 100 for communicating time-domain baseband data can comprise the O-RAN fronthaul interface, a CPRI or enhanced CPRI (eCPRI) digital fronthaul interface format, or a proprietary digital fronthaul interface format (though other digital fronthaul interface formats can also be used).

Another example of a donor unit 104 is a digital donor unit that is configured to communicatively couple the DAS 100 to a baseband entity using a digital baseband fronthaul interface that would otherwise be used to couple the baseband entity to a radio unit (if the DAS 100 were not being used). In the example shown in FIG. 1, two types of digital donor units are shown.

The first type of digital donor unit comprises a digital donor unit 118 that is configured to communicatively couple the DAS 100 to a baseband unit (BBU) 120 using a time-domain baseband fronthaul interface implemented in accordance with a Common Public Radio Interface (“CPRI”) specification. This type of digital donor unit 118 is also referred to here as a “CPRI” donor unit 118, and this type of BBU 120 is also referred to here as a CPRI BBU 120. For each CPRI BBU 120 served by a CPRI donor unit 118, the CPRI donor unit 118 is coupled to the CPRI BBU 120 using the CPRI digital baseband fronthaul interface that would otherwise be used to couple the CPRI BBU 120 to a CPRI remote radio head (RRH) (if the DAS 100 were not being used). A CPRI BBU 120 can be coupled to a corresponding CPRI donor unit 118 via a direct CPRI connection.

Each CPRI donor unit 118 serves as an interface between each served CPRI BBU 120 and the rest of the DAS 100 and receives downlink base station signals from, and outputs uplink base station signals to, each CPRI BBU 120. Each CPRI donor unit 118 performs at least some of the conversion processing necessary to convert the CPRI base station data to and from the digital fronthaul interface format natively used in the DAS 100 for communicating time-domain baseband data. The downlink and uplink base station signals communicated between each CPRI BBU 120 and the CPRI donor unit 118 comprise downlink and uplink fronthaul data generated and formatted in accordance with the CPRI baseband fronthaul interface.

The second type of digital donor unit comprises a digital donor unit 122 that is configured to communicatively couple the DAS 100 to a BBU 124 using a frequency-domain baseband fronthaul interface implemented in accordance with a O-RAN Alliance specification. The acronym “O-RAN” is an abbreviation for “Open Radio Access Network.” This type of digital donor unit 122 is also referred to here as an “O-RAN” donor unit 122, and this type of BBU 124 is typically an O-RAN distributed unit (DU) and is also referred to here as an O-RAN DU 124. For each O-RAN DU 124 served by a O-RAN donor unit 122, the O-RAN donor unit 122 is coupled to the O-DU 124 using the O-RAN digital baseband fronthaul interface that would otherwise be used to couple the O-RAN DU 124 to a O-RAN RU (if the DAS 100 were not being used). An O-RAN DU 124 can be coupled to a corresponding O-RAN donor unit 122 via a switched Ethernet network. Alternatively, an O-RAN DU 124 can be coupled to a corresponding O-RAN donor unit 122 via a direct Ethernet or CPRI connection.

Each O-RAN donor unit 122 serves as an interface between each served O-RAN DU 124 and the rest of the DAS 100 and receives downlink base station signals from, and outputs uplink base station signals to, each O-RAN DU 124. Each O-RAN donor unit 122 performs at least some of any conversion processing necessary to convert the base station signals to and from the digital fronthaul interface format natively used in the DAS 100 for communicating frequency-domain baseband data.

The downlink and uplink base station signals communicated between each O-RAN DU 124 and the O-RAN donor unit 122 comprise downlink and uplink fronthaul data generated and formatted in accordance with the O-RAN baseband fronthaul interface, where the user-plane data comprises frequency-domain baseband IQ data. Also, in this example, the digital fronthaul interface format natively used in the DAS 100 for communicating O-RAN fronthaul data is the same O-RAN fronthaul interface used for communicating base station signals between each O-RAN DU 124 and the O-RAN donor unit 122, and the “conversion” performed by each O-RAN donor unit 122 (and/or one or more other entities of the DAS 100) includes performing any needed “multicasting” of the downlink data received from each O-RAN DU 124 to the multiple RUs 106 in a simulcast zone for that O-RAN DU 124 (for example, by communicating the downlink fronthaul data to an appropriate multicast address and/or by copying the downlink fronthaul data for communication over different fronthaul links) and performing any need combining or summing of the uplink data received from the RUs 106 to produce combined uplink data provided to the O-RAN DU 124. It is to be understood that other digital fronthaul interface formats can also be used.

In general, the various base stations 102 are configured to communicate with a core network (not shown) of the associated wireless operator using an appropriate backhaul network (typically, a public wide area network such as the Internet). Also, the various base stations 102 may be from multiple, different wireless operators and/or the various base stations 102 may support multiple, different wireless protocols and/or RF bands.

In general, for each base station 102, the DAS 100 is configured to receive a set of one or more downlink base station signals from the base station 102 (via an appropriate donor unit 104), generate downlink transport data derived from the set of downlink base station signals, and transmit the downlink transport data to the RUs 106 in the base station's simulcast zone. For each base station 102 served by a given RU 106, the RU 106 is configured to receive the downlink transport data transmitted to it via the DAS 100 and use the received downlink transport data to generate one or more downlink analog radio frequency signals that are radiated from one or more coverage antennas 108 associated with that RU 106 for reception by user equipment 110. In this way, the DAS 100 increases the coverage area for the downlink capacity provided by the base stations 102. Also, for any southbound entities (for example, southbound RUs 106 or ICNs 112) coupled to the RU 106 (for example, in a daisy chain or ring architecture), the RU 106 forwards any downlink transport data intended for those southbound entities towards them.

For each base station 102 served by a given RU 106, the RU 106 is configured to receive one or more uplink radio frequency signals transmitted from the user equipment 110. These signals are analog radio frequency signals and are received via the coverage antennas 108 associated with that RU 106. The RU 106 is configured to generate uplink transport data derived from the one or more remote uplink radio frequency signals received for the served base station 102 and transmit the uplink transport data northbound towards the donor unit 104 coupled to that base station 102.

For each base station 102 served by the DAS 100, a single “combined” set of uplink base station signals or data is produced by a combining or summing process that uses inputs derived from the uplink RF signals received via the RUs 106 in that base station's simulcast zone. The resulting final single combined set of uplink base station signals or data is provided to the base station 102. This combining or summing process can be performed in a centralized manner in which the combining or summing process is performed by a single unit of the DAS 100 (for example, a donor unit 104 or master unit 130). This combining or summing process can also be performed in a distributed or hierarchical manner in which the combining or summing process is performed by multiple units of the DAS 100 (for example, a donor unit 104 (or master unit 130) and one or more ICNs 112 and/or RUs 106). Each unit of the DAS 100 that performs the combining or summing process for a given base station 102 receives uplink transport data from that unit's southbound entities and uses that data to generate combined uplink transport data, which the unit transmits northbound towards the base station 102. The generation of the combined uplink transport data involves, among other things, extracting in-phase and quadrature (IQ) data from the received uplink transport data and performing a combining or summing process using any uplink IQ data for that base station 102 in order to produce combined uplink IQ data.

Some of the details regarding how base station signals or data are communicated and transport data is produced vary based on which type of base station 102 is being served. In the case of an RF-interface base station 116, the associated RF donor unit 114 receives analog downlink RF signals from the RF-interface base station 116 and, either alone or in combination with one or more other units of the DAS 100, converts the received analog downlink RF signals to the digital fronthaul interface format natively used in the DAS 100 for communicating time-domain baseband data (for example, by digitizing, digitally down-converting, and filtering the received analog downlink RF signals in order to produce digital baseband IQ data and formatting the resulting digital baseband IQ data into packets) and communicates the resulting packets of downlink transport data to the various RUs 106 in the simulcast zone of that base station 116. The RUs 106 in the simulcast zone for that base station 116 receive the downlink transport data and use it to generate and radiate downlink RF signals as described above. In the uplink, either alone or in combination with one or more other units of the DAS 100, the RF donor unit 114 generates a set of uplink base station signals from uplink transport data received by the RF donor unit 114 (and/or the other units of the DAS 100 involved in this process). The set of uplink base station signals is provided to the served base station 116. The uplink transport data is derived from the uplink RF signals received at the RUs 106 in the simulcast zone of the served base station 116 and communicated in packets.

In the case of a CPRI BBU 120, the associated CPRI digital donor unit 118 receives CPRI downlink fronthaul data from the CPRI BBU 120 and, either alone or in combination with another unit of the DAS 100, converts the received CPRI downlink fronthaul data to the digital fronthaul interface format natively used in the DAS 100 for communicating time-domain baseband data (for example, by re-sampling, synchronizing, combining, separating, gain adjusting, etc. the CPRI baseband IQ data, and formatting the resulting baseband IQ data into packets), and communicates the resulting packets of downlink transport data to the various RUs 106 in the simulcast zone of that CPRI BBU 120. The RUs 106 in the simulcast zone of that CPRI BBU 120 receive the packets of downlink transport data and use them to generate and radiate downlink RF signals as described above. In the uplink, either alone or in combination with one or more other units of the DAS 100, the CPRI donor unit 118 generates uplink base station data from uplink transport data received by the CPRI donor unit 118 (and/or the other units of the DAS 100 involved in this process). The resulting uplink base station data is provided to that CPRI BBU 120. The uplink transport data is derived from the uplink RF signals received at the RUs 106 in the simulcast zone of the CPRI BBU 120.

In the case of an O-RAN DU 124, the associated O-RAN donor unit 122 receives packets of O-RAN downlink fronthaul data (that is, O-RAN user-plane and control-plane messages) from each O-RAN DU 124 coupled to that O-RAN digital donor unit 122 and, either alone or in combination with another unit of the DAS 100, converts (if necessary) the received packets of O-RAN downlink fronthaul data to the digital fronthaul interface format natively used in the DAS 100 for communicating O-RAN baseband data and communicates the resulting packets of downlink transport data to the various RUs 106 in a simulcast zone for that ORAN DU 124. The RUs 106 in the simulcast zone of each O-RAN DU 124 receive the packets of downlink transport data and use them to generate and radiate downlink RF signals as described above. In the uplink, either alone or in combination with one or more other units of the DAS 100, the O-RAN donor unit 122 generates packets of uplink base station data from uplink transport data received by the O-RAN donor unit 122 (and/or the other units of the DAS 100 involved in this process). The resulting packets of uplink base station data are provided to the O-RAN DU 124. The uplink transport data is derived from the uplink RF signals received at the RUs 106 in the simulcast zone of the served O-RAN DU 124 and communicated in packets.

In one implementation, one of the units of the DAS 100 is also used to implement a “master” timing entity for the DAS 100 (for example, such a master timing entity can be implemented as a part of a master unit 130 described below). In another example, a separate, dedicated timing master entity (not shown) is provided within the DAS 100. In either case, the master timing entity synchronizes itself to an external timing master entity (for example, a timing master associated with one or more of the O-DUs 124) and, in turn, that entity serves as a timing master entity for the other units of the DAS 100. A time synchronization protocol (for example, the Institute of Electrical and Electronics Engineers (IEEE) 1588 Precision Time Protocol (PTP), the Network Time Protocol (NTP), or the Synchronous Ethernet (SyncE) protocol) can be used to implement such time synchronization.

A management system can be used to manage the various nodes of the DAS 100. In one implementation, the management system communicates with a predetermined “master” entity for the DAS 100 (for example, the master unit 130 described below), which in turns forwards or otherwise communicates with the other units of the DAS 100 for management-plane purposes. In another implementation, the management system communicates with the various units of the DAS 100 directly for management-plane purposes (that is, without using a master entity as a gateway).

Each base station 102 (including each RF-interface base station 116, CPRI BBU 120, and O-RAN DU 124), donor unit 104 (including each RF donor unit 114, CPRI donor unit 118, and O-RAN donor unit 122), RU 106, ICN 112, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.). Such entities can be implemented in other ways.

The DAS 100 can be implemented in a virtualized manner or a non-virtualized manner. When implemented in a virtualized manner, one or more nodes, units, or functions of the DAS 100 are implemented using one or more virtual network functions (VNFs) executing on one or more physical server computers (also referred to here as “physical servers” or just “servers”) (for example, one or more commercial-off-the-shelf (COTS) servers of the type that are deployed in data centers or “clouds” maintained by enterprises, communication service providers, or cloud services providers). More specifically, in the exemplary embodiment shown in FIG. 1, each O-RAN donor unit 122 is implemented as a VNF running on a server 126. The server 126 can execute other VNFs 128 that implement other functions for the DAS 100 (for example, fronthaul, management plane, and synchronization plane functions). The various VNFs executing on the server 126 are also referred to here as “master unit” functions 130 or, collectively, as the “master unit” 130. Also, in the exemplary embodiment shown in FIG. 1, each ICN 112 is implemented as a VNF running on a server 132.

The RF donor units 114 and CPRI donor units 118 can be implemented as cards (for example, Peripheral Component Interconnect (PCI) Cards) that are inserted in the server 126. Alternatively, the RF donor units 114 and CPRI donor units 118 can be implemented as separate devices that are coupled to the server 126 via dedicated Ethernet links or via a switched Ethernet network (for example, the switched Ethernet network 134 described below).

In the exemplary embodiment shown in FIG. 1, the donor units 104, RUs 106 and ICNs 112 are communicatively coupled to one another via a switched Ethernet network 134. Also, in the exemplary embodiment shown in FIG. 1, an O-RAN DU 124 can be coupled to a corresponding O-RAN donor unit 122 via the same switched Ethernet network 134 used for communication within the DAS 100 (though each O-RAN DU 124 can be coupled to a corresponding O-RAN donor unit 122 in other ways). In the exemplary embodiment shown in FIG. 1, the downlink and uplink transport data communicated between the units of the DAS 100 is formatted as O-RAN data that is communicated in Ethernet packets over the switched Ethernet network 134. In the exemplary embodiment shown in FIG. 1, the RF donor units 114 and CPRI donor units 118 are coupled to the RUs 106 and ICNs 112 via the master unit 130.

In the downlink, the RF donor units 114 and CPRI donor units 118 provide downlink time-domain baseband IQ data to the master unit 130. The master unit 130 generates downlink O-RAN user-plane messages containing downlink baseband IQ that is either the time-domain baseband IQ data provided from the donor units 114 and 118 or is derived therefrom (for example, where the master unit 130 converts the received time-domain baseband IQ data into frequency-domain baseband IQ data). The master unit 130 also generates corresponding downlink O-RAN control-plane messages for those O-RAN user-plane messages. The resulting downlink O-RAN user-plane and control-plane messages are communicated (multicasted) to the RUs 106 in the simulcast zone of the corresponding base station 102 via the switched Ethernet network 134.

In the uplink, for each RF-interface base station 116 and CPRI BBU 120, the master unit 130 receives O-RAN uplink user-plane messages for the base station 116 or CPRI BBU 120 and performs a combining or summing process using the uplink baseband IQ data contained in those messages in order to produce combined uplink baseband IQ data, which is provided to the appropriate RF donor unit 114 or CPRI donor unit 118. The RF donor unit 114 or CPRI donor unit 118 uses the combined uplink baseband IQ data to generate a set of base station signals or CPRI data that is communicated to the corresponding RF-interface base station 116 or CPRI BBU 120. If time-domain baseband IQ data has been converted into frequency-domain baseband IQ data for transport over the DAS 100, the donor unit 114 or 118 also converts the combined uplink frequency-domain IQ data into combined uplink time-domain IQ data as part of generating the set of base station signals or CPRI data that is communicated to the corresponding RF-interface base station 116 or CPRI BBU 120.

In the exemplary embodiment shown in FIG. 1, the master unit 130 (more specifically, the O-RAN donor unit 122) receives downlink O-RAN user-plane and control-plane messages from each served O-RAN DU 124 and communicates (multicasts) them to the RUs 106 in the simulcast zone of the corresponding O-RAN DU 124 via the switched Ethernet network 134. In the uplink, the master unit 130 (more specifically, the O-RAN donor unit 122) receives O-RAN uplink user-plane messages for each served O-RAN DU 124 and performs a combining or summing process using the uplink baseband IQ data contained in those messages in order to produce combined uplink IQ data. The O-RAN donor unit 122 produces O-RAN uplink user-plane messages containing the combined uplink baseband IQ data and communicates those messages to the O-RAN DU 124.

In the exemplary embodiment shown in FIG. 1, only uplink transport data is communicated using the ICNs 112, and downlink transport data is communicated from the master unit 130 to the RUs 106 without being forwarded by, or otherwise communicated using, the ICNs 112.

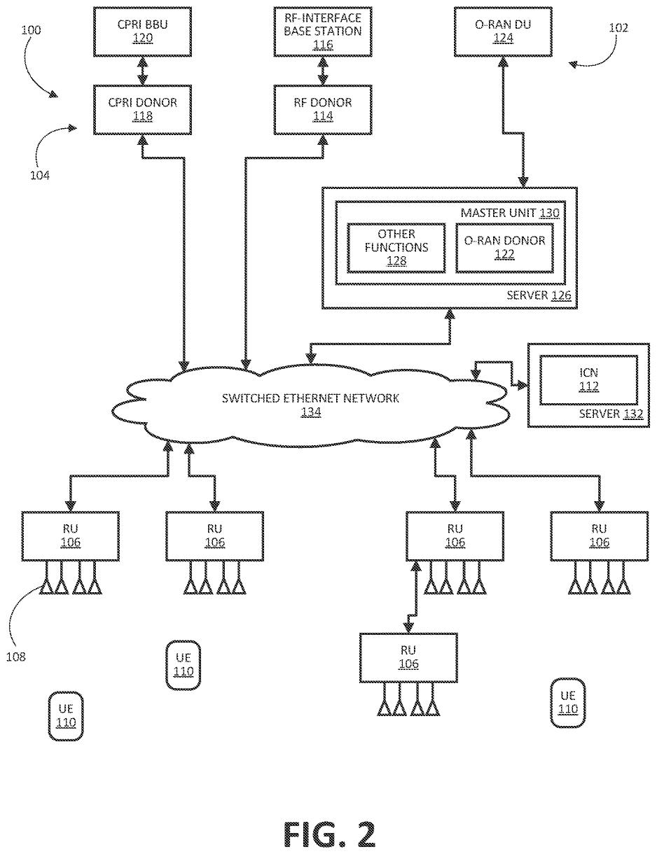

FIG. 2 illustrates another exemplary embodiment of a DAS 100. The DAS 100 shown in FIG. 2 is the same as the DAS 100 shown in FIG. 1 except as described below. In the exemplary embodiment shown in FIG. 2, the RF donor units 114 and CPRI donor units 118 are coupled directly to the switched Ethernet network 134 and not via the master unit 130, as is the case in the embodiment shown in FIG. 1.

As described above, in the exemplary embodiment shown in FIG. 1, the master unit 130 performs some transport functions related to serving the RF-interface base stations 116 and CPRI BBUs 120 coupled to the donor units 114 and 118. In the exemplary embodiment shown in FIG. 2, the RF donor units 114 and CPRI donor units 118 perform those transport functions (that is, the RF donor units 114 and CPRI donor units 118 perform all of the transport functions related to serving the RF-interface base stations 116 and CPRI BBUs 120, respectively).

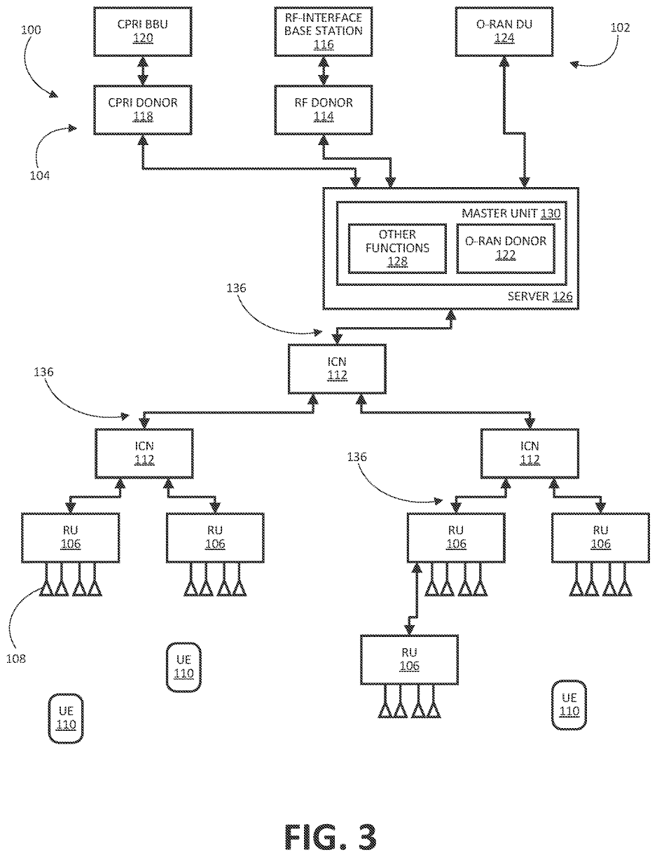

FIG. 3 illustrates another exemplary embodiment of a DAS 100. The DAS 100 shown in FIG. 3 is the same as the DAS 100 shown in FIG. 1 except as described below. In the exemplary embodiment shown in FIG. 3, the donor units 104, RUs 106 and ICNs 112 are communicatively coupled to one another via point-to-point Ethernet links 136 (instead of a switched Ethernet network). Also, in the exemplary embodiment shown in FIG. 3, an O-RAN DU 124 can be coupled to a corresponding O-RAN donor unit 122 via a switched Ethernet network (not shown in FIG. 3), though that switched Ethernet network is not used for communication within the DAS 100. In the exemplary embodiment shown in FIG. 3, the downlink and uplink transport data communicated between the units of the DAS 100 is communicated in Ethernet packets over the point-to-point Ethernet links 136.

For each southbound point-to-point Ethernet link 136 that couples a master unit 130 to an ICN 112, the master unit 130 assembles downlink transport frames and communicates them in downlink Ethernet packets to the ICN 112 over the point-to-point Ethernet link 136. For each point-to-point Ethernet link 136, each downlink transport frame multiplexes together downlink time-domain baseband IQ data and Ethernet data that needs to be communicated to southbound RUs 106 and ICNs 112 that are coupled to the master unit 130 via that point-to-point Ethernet link 136. The downlink time-domain baseband IQ data is sourced from one or more RF donor units 114 and/or CPRI donor units 118. The Ethernet data comprises downlink user-plane and control-plane O-RAN fronthaul data sourced from one or more O-RAN donor units 122 and/or management-plane data sourced from one or more management entities for the DAS 100. That is, this Ethernet data is encapsulated into downlink transport frames that are also used to communicate downlink time-domain baseband IQ data and this Ethernet data is also referred to here as “encapsulated” Ethernet data. The resulting downlink transport frames are communicated in the payload of downlink Ethernet packets communicated from the master unit 130 to the ICN 112 over the point-to-point Ethernet link 136. The Ethernet packets into which the encapsulated Ethernet data is encapsulated are also referred to here as “transport” Ethernet packets.

Each ICN 112 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. Any encapsulated Ethernet data that is intended for the ICN 112 (for example, management-plane Ethernet data) is processed by the ICN 112.

For each southbound point-to-point Ethernet link 136 coupled to the ICN 112, the ICN 112 assembles downlink transport frames and communicates them in downlink Ethernet packets to the southbound entities subtended from the ICN 112 via the point-to-point Ethernet link 136. For each southbound point-to-point Ethernet link 136, each downlink transport frame multiplexes together downlink time-domain baseband IQ data and Ethernet data received at the ICN 112 that needs to be communicated to those subtended southbound entities. The resulting downlink transport frames are communicated in the payload of downlink transport Ethernet packets communicated from the ICN 112 to those subtended southbound entities ICN 112 over the point-to-point Ethernet link 136.

Each RU 106 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. As described above, the RU 106 uses any downlink time-domain baseband IQ data and/or downlink O-RAN user-plane and control-plane fronthaul messages to generate downlink RF signals for radiation from the set of coverage antennas 108 associated with that RU 106. The RU 106 processes any management-plane messages communicated to that RU 106 via encapsulated Ethernet data.

Also, for any southbound point-to-point Ethernet link 136 coupled to the RU 106, the RU 106 assembles downlink transport frames and communicates them in downlink Ethernet packets to the southbound entities subtended from the RU 106 via the point-to-point Ethernet link 136. For each southbound point-to-point Ethernet link 136, each downlink transport frame multiplexes together downlink time-domain baseband IQ data and Ethernet data received at the RU 106 that needs to be communicated to those subtended southbound entities. The resulting downlink transport frames are communicated in the payload of downlink transport Ethernet packets communicated from the RU 106 to those subtended southbound entities ICN 112 over the point-to-point Ethernet link 136.

In the uplink, each RU 106 generates uplink time-domain baseband IQ data and/or uplink O-RAN user-plane fronthaul messages for each RF-interface base station 116, CPRI BBU 120, and/or O-RAN DU 124 served by that RU 106 as described above. For each northbound point-to-point Ethernet link 136 of the RU 106, the RU 106 assembles uplink transport frames and communicates them in uplink transport Ethernet packets northbound towards the appropriate master unit 130 via that point-to-point Ethernet link 136. For each northbound point-to-point Ethernet link 136, each uplink transport frame multiplexes together uplink time-domain baseband IQ data originating from that RU 106 and/or any southbound entity subtended from that RU 106 as well as any Ethernet data originating from that RU 106 and/or any southbound entity subtended from that RU 106. In connection with doing this, the RU 106 performs the combining or summing process described above for any base station 102 served by that RU 106 and also by one or more of the subtended entities. (The RU 106 forwards northbound all other uplink data received from those southbound entities.) The resulting uplink transport frames are communicated in the payload of uplink transport Ethernet packets northbound towards the master unit 130 via the associated point-to-point Ethernet link 136.

Each ICN 112 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. For each northbound point-to-point Ethernet link 136 coupled to the ICN 112, the ICN 112 assembles uplink transport frames and communicates them in uplink transport Ethernet packets northbound towards the master unit 130 via that point-to-point Ethernet link 136. For each northbound point-to-point Ethernet link 136, each uplink transport frame multiplexes together uplink time-domain baseband IQ data and Ethernet data received at the ICN 112 that needs to be communicated northbound towards the master unit 130. The resulting uplink transport frames are communicated in the payload of uplink transport Ethernet packets communicated northbound towards the master unit 130 over the point-to-point Ethernet link 136.

Each master unit 130 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. Any extracted uplink time-domain baseband IQ data, as well as any uplink O-RAN messages communicated in encapsulated Ethernet, is used in producing a single “combined” set of uplink base station signals or data for the associated base station 102 as described above (which includes performing the combining or summing process). Any other encapsulated Ethernet data (for example, management-plane Ethernet data) is forwarded on towards the respective destination (for example, a management entity).

In the exemplary embodiment shown in FIG. 3, synchronization-plane messages are communicated using native Ethernet packets (that is, non-encapsulated Ethernet packets) that are interleaved between the transport Ethernet packets.

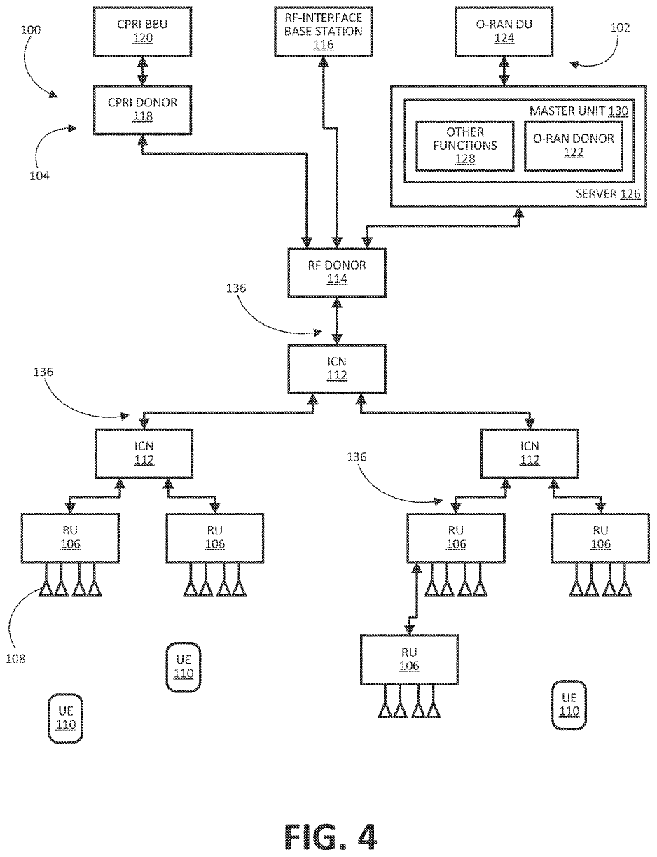

FIG. 4 illustrates another exemplary embodiment of a DAS 100. The DAS 100 shown in FIG. 4 is the same as the DAS 100 shown in FIG. 3 except as described below. In the exemplary embodiment shown in FIG. 4, the CPRI donor units 118, O-RAN donor unit 122, and master unit 130 are coupled to the RUs 106 and ICNs 112 via one or more RF units 114. That is, each RF unit 114 performs the transport frame multiplexing and demultiplexing that is described above in connection with FIG. 3 as being performed by the master unit 130.

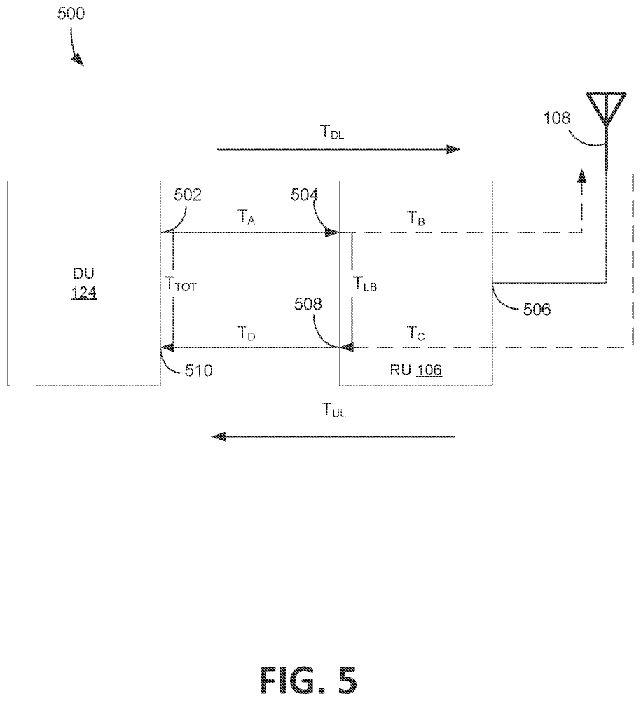

FIG. 5 depicts a block diagram of a radio access network including a distributed unit coupled to a radio unit. Although not explicitly shown in FIG. 5, the DU 124 may form part of a logical baseband entity that also comprises a central unit (CU). The DU 124 can be communicatively coupled to the RU 106 through an appropriate interface, such as an O-RAN interface as described in the context of FIGS. 1-4. Multiple RUs 106 can also be coupled to DU 124 in the RAN 500. Other RAN architectures can be used.

DU 124 is communicatively coupled to each RU 106 through at least one signal path defined by I/O port 502 and I/O port 504 and at least one uplink signal path defined by I/O port 508 and I/O port 510. RU 106 also comprises an I/O port 506 that defines a signal path to antenna 108. In various implementations, the signals transmitted between the DU 124 and RU 106 can include downlink/uplink signals containing control-plane and user-plane data, test signals transmitted as part of a messaging protocol for RAN operation (e.g., fault detection signals, control signals for RU configuration, transport connectivity verification signals), and other types of messaging protocols. As a specific example, the signals transmitted between the DU 124 and RU 106 are part of a loopback messaging protocol in which the DU 124 sends a query signal to the RU 106 and the RU responds by sending a response signal back to the DU 124. One example of such a loopback messaging protocol is loopback messaging (LBM), conventionally used for verification of transport connectivity status between RAN or DAS nodes. Other types of protocols can be used.

A signal transmitted by one node will take a period of time before it is received by another node in the signal path (referred to as a “signal path delay” or “signal path time delay”). For example, a signal transmitted by DU 124 will experience a time delay T_{A} from the time it is transmitted from I/O port 502 to when it is received by RU 106 at I/O port 504. Additionally, a signal will experience a time delay T_{B} from the time it is received at RU 106 to the time the signal reaches antenna 108. The total downlink time delay in this example will be T_{A}+T_{B}. In the uplink direction, a signal will experience a time delay T_{C} from the time it is received at antenna 108 to the time it is transmitted from the RU 106 at I/O port 508. There is a further time delay T_{D} associated with the time in which the signal is transmitted at I/O port 508 to the time in which the signal is received at the I/O port 510 of DU 124. Thus, the total round trip time from DU 124 I/O port 502 to the antenna 108 and from the antenna 108 to DU 124 I/O port 510 is T_{TOT}=T_{A}+T_{B}+T_{C}+T_{D}.

To calculate the time delays T_{A} and T_{D} (which are typically due to optical fibers of unknown length), the DU 124 can send a bidirectional timing message to the RU 106 and receive a response message back from the RU 106, including the loopback processing delay T_{LB} either separately or in the same response. In addition, the inherent delays of the RU 106 T_{B} and T_{C} are known by the RU and communicated to the DU via messaging. By determining the total delay ΔT (ΔT=T_{A}+T_{LB}+T_{D}) to the timing message and knowing the RU loopback delay (T_{LB}), and assuming T_{A} and T_{D} are equal, the time delays T_{A} and T_{D} can be calculated from the equations T_{A} =T_{D}=(ΔT−T_{LB})/2. In RAN systems, each of these time delays may have a certain threshold tolerance, which varies depending on the specific implementation.

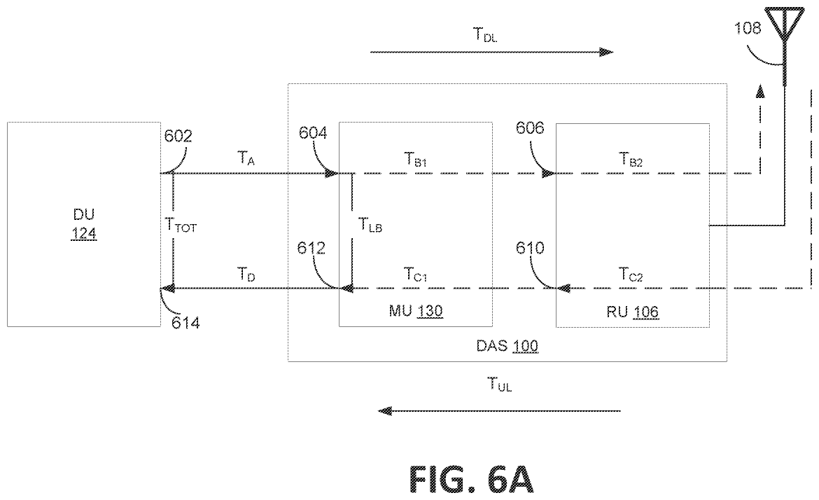

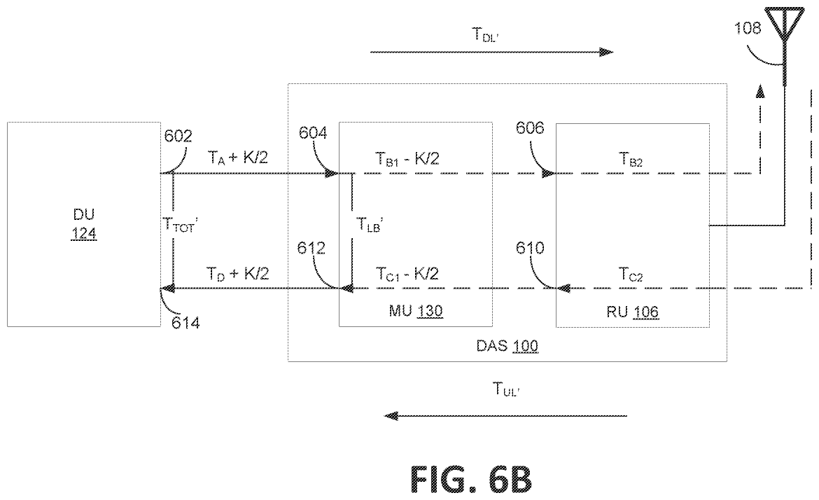

In some implementations, the RAN 500 can be coupled to a DAS 100 as shown in FIG. 6A. The example DAS 100 shown in FIG. 6A can include at least one master unit (MU) 130 (shown as a single master unit for simplicity) communicatively coupled to at least one RU 106 (shown as a single radio unit for simplicity). Referring to FIGS. 5-6, the time delay T_{B} of a signal is separated into two distinct components due to the inclusion of the DAS 100, specifically T_{B1}, which is defined by the time from when the signal is received by the MU 130 at I/O port 604 to the reception of the signal at I/O port 606, and T_{B2}, which is defined by the time from when the signal is received by the RU 106 at I/O port 606 to the reception of the signal at antenna 108. Thus, T_{B}=T_{B1}+T_{B2}. In similar fashion, the delay T_{C} is separated into two distinct components so that T_{C}=T_{C1}+T_{C2}. The total downlink time delay is T_{DL}=T_{A}+T_{B1}+T_{B2}, and the total uplink time delay is T_{UL}=T_{D}+T_{C1}+T_{C2}. Accordingly, the total round trip time from the DU to the antenna is T_{TOT}=T_{DL}+T_{UL}.

In some situations, the DAS 100 experiences a larger delay than what would be anticipated by the RAN (e.g., from the perspective of DU 124). For example, the delay T_{B1}+T_{B2} may exceed an allowable threshold set for T_{B} such that T_{B1}+T_{B2}>T_{BMax} and/or the delay T_{C1}+T_{C2} may exceed an allowable threshold set for T_{C} such that T_{C1}+T_{C2}>T_{CMax}. Such a situation is more likely to occur when the transmission time T_{B1} and T_{C1} are long, which typically corresponds to when the MU 130 and RU 106 are located remotely from each other. For example, consider the propagation of a signal in the system as shown in FIG. 6B. When the signal propagates through the signal path defined by I/O port 602 and I/O port 604, it will occur a delay T_{A} as previously described, and the actual delays associated with each of the signal paths are T_{A}, T_{B1}, T_{B2}to the antenna 108, and T_{C2}, T_{C1}, and T_{D} when a signal from the antenna reaches I/O port 614 of DU 124. In this example, however, the total roundtrip delay of the DAS 100 (T_{RT}=T_{B1}+T_{B2}+T_{C2}+T_{C1}) exceeds the maximum allowable delay caused by the DAS 100, T_{B1}+T_{B2}>T_{BMax}, T_{C2}+T_{C1}>T_{CMax}.

To accommodate for longer delays caused by signal propagation in the DAS 100, the DAS 100 is configured to determine an apparent signal path delay of one or more signal paths so that even when the DAS 100 experiences a downlink and/or uplink delay greater than an allowable threshold, the DU 124 perceives a DAS delay within allowable constraints. Referring to FIG. 6B, to do this the DAS 100 determines an “apparent” delay by applying a delay variable K to the determined delay of one or more signal paths. The apparent delay is artificial in the sense that it is not actually the delay caused by propagating the signal in a given signal path, but rather is an artificial modification of the actual delay time. The delay variable K can be any positive valued quantity represented as a delay value, and is determined so that the total DAS delay does not exceed an allowable delay threshold imposed by the RAN. For example, the delay variable can be set based on the actual determined delay for the signal path and the allowable delay threshold level for that signal path. In one simple implementation, the delay variable K is the difference between the maximum roundtrip delay threshold T_{RTMax} and the actual roundtrip delay T_{RT}. In other examples, the maximum delay threshold can be defined as a maximum value for the maximum downlink sum T_{DLMax}=T_{AMax}+T_{BMax} or the maximum uplink sum T_{ULMax}=T_{CMax}+T_{DMax} corresponding to the maximum time it would take to transmit and receive the signal from/by the DU 124 if the DAS 100 were not coupled downstream from the DU 124.

In the example shown in FIG. 6B, the delay from the DAS 100 can be tolerated by increasing the loopback message processing delay T_{LB} by K. When the DU 124 sends a timing message to the MU 130, the MU 130 responds back to the DU 124 with a message that the loopback processing delay is T_{LB} (the apparent loopback processing delay) when in reality the loopback processing delay is T_{LB}′=T_{LB}+K. This causes the DU 124 to calculate the delays between the DU 124 and the MU 130 to be T_{A}′=T_{D}′=T_{A}+K/2. That is, by reporting an apparent loopback processing delay T_{LB} less than the actual loopback processing delay T_{LB}′, the MU 130 deceives the DU 124 into calculating a longer delay T_{A}′, T_{D}′ than what the delays actually are (T_{A}, T_{D}). These apparent delays T_{A}′, T_{D}′ are subsequently used for accommodating additional delay for signal propagation on the DAS 100 end.

Because MU 130 has reported a loopback processing delay T_{LB} (instead of the higher value T_{LB}′) and caused DU 124 to effectively increase the delays T_{A} and T_{D} by a respective value of K/2, the DAS 100 is able to report an apparent signal path delay (e.g., a downlink, uplink, and/or a roundtrip delay) less than the actual signal path delay. In so doing, the DAS 100 can represent the delay(s) associated with signal propagation in the DAS 100 to be within allowable tolerances imposed by the RAN 500 (even when the actual delays are not in fact below the tolerances). For example, as shown in FIG. 6B, the apparent delay T_{B1}′ is determined from subtracting a value of K/2 from the actual delay T_{B1} to yield T_{B1}′=T_{B1}−K/2. Thus, the total DAS downlink delay is T_{B}′=T_{B1}′+T_{B2}=T_{B1}+T_{B2}−K/2. Similarly, the apparent delay T_{C1}′ is determined from subtracting a value of K/2 from the actual delay T_{C1} to yield T_{C1}′=T_{C1}−K/2. Thus, the total DAS uplink delay is T_{C}′=T_{C1}+T_{C2}′=T_{C1}+T_{C2}−K/2. The total apparent roundtrip delay T_{RT}′ is then calculated to be T_{RT}′=T_{B}′+T_{C}′=T_{B}+T_{C}−K. Any of these apparent delays can be reported to the DU 124. The total downlink delay T_{DL} is still T_{A}+T_{B1}+T_{B2}, and since the RU 106 “thinks” the delay between I/O port 602 and I/O port 604 is T_{A}′=T_{A}+K/2, it infers the DAS downlink delay between I/O port 604 and the antenna 108 is T_{B1}+T_{B2}−K/2. The total uplink delay TUL is applied in a similar manner.

While the actual delays T_{B1}, T_{B2}, T_{C1}, T_{C2} are used to calculate the apparent delay that is reported by the DAS 100, the actual delays are not themselves modified since they are the measured delays in the DAS 100. Rather, the actual delays T_{B1}, T_{B2}, T_{C1}, T_{C2} are used to calculate the apparent delay(s) that are reported by the DAS 100, and the DU 124 is “oblivious” to the actual delays when determining the total roundtrip delay, total downlink delay, and/or total uplink delay. In determining the apparent delays based on the delay variable K, the apparent delay reported by the DAS 100 is within the allowable tolerance, since by reducing the roundtrip delay by K, the apparent roundtrip delay T_{RT}′, for example, is less than (or equal to) the maximum roundtrip tolerance; that is, T_{RT}′=T_{B1}+T_{B2}+T_{C1}+T_{C2}−K<=T_{RTMax}.

Still referring to FIG. 6B, DU 124 receives a message from MU 130 with the appropriate apparent delay, e.g., the apparent DAS roundtrip delay T_{RT}′. Because the apparent roundtrip delay is less than the actual roundtrip delay T_{RT}, and is below the delay threshold for roundtrip propagation in the DAS 100, the DU 124 “believes” the roundtrip delay to be T_{RT}′ and that the roundtrip propagation in the DAS 100 is within allowable constraints (when in fact neither condition is true). In the example shown in FIG. 6B, DU 124 assumes that the delay T_{A}′=T_{D}′ and that the total roundtrip delay T_{TOT} is T_{TOT}=T_{RT}′+T_{A}′+T_{D}′. DU 124 is unaware of the actual roundtrip time T_{RT} and assumes that the time it took a downlink signal to propagate from I/O port 602 to I/O port 604 is T_{A}′ (T_{A}′=T_{A}+K/2), and the time it took an uplink signal to propagate from I/O port 612 to I/O port 614 is T_{D}′ (T_{D}′=T_{D}+K/2). In actuality, the time for the downlink signal to propagate this distance is T_{A} and the time for the uplink signal to propagate this distance is T_{D}, both of which are a value of K/2 less than their respective apparent delays T_{A}′, T_{D}′ determined by the DU 124. Accordingly, DU 124 (inadvertently) compensates for the apparent delay reported by DAS 100 from the larger values of T_{A}′ (instead of T_{A}) and T_{D}′ (instead of T_{D}). In totality, the total apparent downlink delay is equal to the actual total downlink delay (T_{DL}=T_{A}+T_{B}=T_{A}′+T_{B}′=(T_{A}+K/2)+(T_{B}−K/2)=T_{DL}′), the total apparent uplink delay is equal to the actual total uplink delay (T_{UL}=T_{D}+T_{C}=T_{D}′+T_{C}′=(T_{D}+K/2)+(T_{C}−K/2)=T_{UL}′), and thus the apparent total roundtrip time is equal to the actual total roundtrip time (T_{TOT}′=T_{TOT}). Importantly however, DU 124 determines that the delays due to propagation in the DAS 100 are within allowable constraints and so the DAS 100 (and the system more generally) is able to operate normally and tolerate some additional delay from the DAS 100.

To illustrate the principles of artificial delay manipulation, consider a numerical example in which the actual delays are given by T_{A}=T_{D}=10, T_{B1}=T_{C1}=20, and T_{B2}=T_{C2}=25. (Assume the numerical quantities are in arbitrary units of time for pedagogical explanation.) Also assume that there is a processing delay T_{LB}=4 associated with the MU 130 to respond to a loopback message sent from DU 124. In this example, DU 124 sends a query message to the MU 130 for the loopback processing delay T_{LB} to use for calculating the other delay parameters T_{A}, T_{D}. Therefore, it takes a total of T_{A}+T_{LB}+T_{D}=10+4+10=24 for DU 124 to receive a response loopback message from MU 130. If MU 130 immediately reported the actual loopback processing delay T_{LB}−4 in the response loopback message, then DU 124 would calculate T_{A}, T_{D} to be T_{A}=T_{D}=(24−4)/2=10, the same values as the actual values previously defined in this numerical example.

Instead, however, MU 130 increases the loopback processing delay T_{LB} to a value of T_{LB}′=T_{LB}+K=4+8=12 before sending the response loopback message to DU 124. Even though the loopback processing delay has been increased by K, MU 130 reports to DU 124 in the response message that the loopback processing delay is T_{LB}=4 (the same value that MU 130 would have reported if it had not increased the loopback processing delay of the response and immediately responded to DU 124). Since MU 130 increased the loopback processing delay to T_{LB}′=12, DU 124 then determines that the total loopback time delay in receiving the loopback response message from MU 130 is the sum of the total delays T_{A} and T_{D} (whose values are both still unknown to DU 124) and T_{LB}′; that is, the total loopback time delay perceived by DU 124 is 10+10+12=32. But because MU 130 reports a loopback processing delay T_{LB}=4, DU 124 calculates the delays T_{A}, T_{B} to be the apparent values T_{A}′=T_{D}′=(32−4)/2=14. Thus, in relying on the apparent loopback processing delay reported by MU 130, DU determines T_{A} and T_{D} to be T_{A}′ and T_{D}′, respectively, a value of K/2 higher than their respective values. Stated differently, DU 124 determines the apparent delays T_{A}′, T_{D}′, a value of K/2 more than the actual delays T_{A}, T_{D} associated with transmitting/receiving signals to/from MU 130.

In relying on the increased apparent delays T_{A}′, T_{D}′, the DAS 100 can effectively increase the amount of tolerance for processing downlink and/or uplink messages imposed by the RAN 500 (e.g., the DU 124). Because MU 130 caused DU 124 to effectively increase the delay between the DU 124 and DAS 100 to an additional value K, then the DAS 100 effectively has an additional tolerance K by which to report the delays associated with processing downlink and/or uplink messages in the DAS 100. In the example shown in FIG. 6B, the DAS 100 (e.g., MU 130) reports to DU 124 that the apparent downlink DAS delay is T_{B}′=T_{B}−K/2 and the apparent uplink DAS delay is T_{C}′=T_{C}−K/2 (when in reality the downlink DAS delay is T_{B} and the uplink DAS delay is T_{C}). Even if the actual delays would exceed the respective maximum threshold delays T_{B}>T_{BMax} and T_{C}>T_{CMax}, the excessive DAS delay is tolerated by the RAN 500 because it is attributed to the increased values T_{A}′, T_{D}′ instead of unallowable delay above the maximum threshold. Notably, the total actual downlink delay T_{DL} and the total apparent downlink delay T_{DL}′ as perceived by DU 124 remains the same; that is, T_{DL}=T_{A}+T_{B}=T_{A}′+T_{B}′=T_{DL}′, since T_{A}′=T_{A}+K/2 and T_{B}′=T_{B}−K/2. Similarly, the total actual uplink delay T_{UL} and the total apparent uplink delay T_{UL}′ as perceived by DU 124 remains the same, so that T_{UL}=T_{C}+T_{D}=T_{C}′+T_{D}′=T_{UL}′, since T_{C}′=T_{C}−K/2 and T_{D}′=T_{D}+K/2. DU 124 perceives (incorrectly) the downlink delay to be (T_{A}+K/2)+(T_{B}−K/2) and the uplink delay to be (T_{C}−K/2)+(T_{D}+K/2).

The apparent delay can be determined in different ways. In some examples, different portions of the apparent downlink and apparent uplink delay are determined by MU 130 and reported to the DU 124. For example, both apparent signal path delays T_{B1}′ and T_{B2}′ can be determined such that T_{B1}′=T_{B1}−K/4 and T_{B2}′=T_{B2}−K/4 in the downlink direction, and in the uplink direction, T_{C2}′ (defined as the apparent signal path delay between antenna 108 and I/O port 610) is given by T_{C2}′=T_{C2}−K/4 and T_{C1}′=T_{C1}−K/4. Alternatively, different portions can be modified with different variable quantities. In one example, T_{B1}′=T_{B1}−K/3 and T_{B2}′=T_{B2}−K/6 in the downlink direction and T_{C2}′=T_{C2}−K/6 and T_{C1}′=T_{C1}−K/3 in the uplink direction. In further examples, the delay variable K can be represented as other quantities, such as a function and/or can be dynamically adjusted. MU 130 can report any of these downlink and uplink delay components to DU 124.

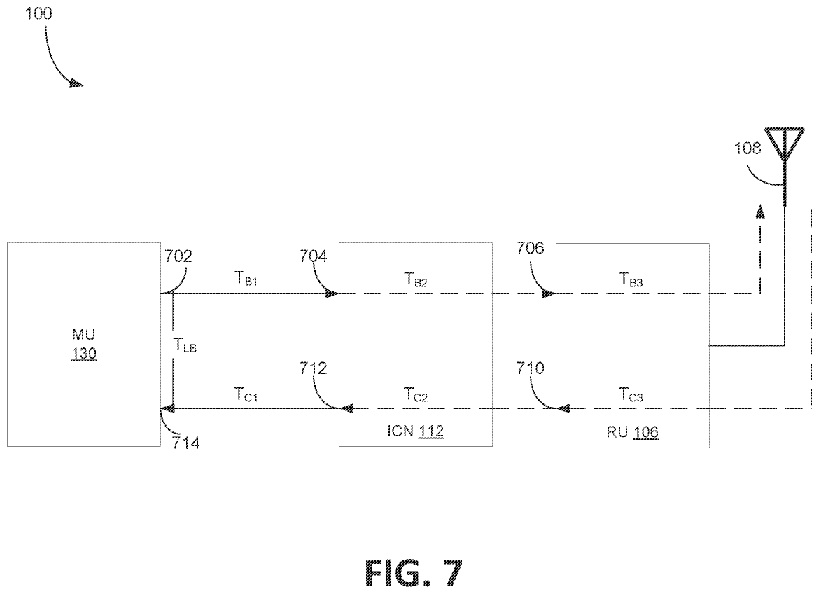

In some examples, the DAS 100 includes additional nodes coupled between the MU 130 and the RU 106. For example, FIG. 7 depicts a block diagram of a distributed antenna system including a master unit, an intermediate combining node, and a radio unit. In the example shown in FIG. 7, the DAS downlink delay T_{B} is separated into three components T_{B1}, T_{B2}, T_{B3}, where T_{B1} is the delay associated with the signal path defined from the I/O port 702 of MU 130 to the I/O port 704 of ICN 112, T_{B2} is the delay associated with the signal path defined from the I/O port 704 of ICN 112 to the I/O port 706 of RU 106, and T_{B3} is the delay associated with the signal path defined from the I/O port 706 of RU 106 to the antenna 108. In the uplink direction, the DAS uplink delay T_{C} is further separated into three components T_{C1}, T_{C2}, T_{C3}, where T_{C3} is the delay associated with the signal path defined from the antenna 108 to the I/O port 710 of RU 106, T_{C2} is the delay associated with the signal path defined from the I/O port of RU 106 to the I/O port 712 of ICN 112, and T_{C1} is the delay associated with the signal path defined from the I/O port of ICN 112 to the I/O port 714 of MU 130. The delays referred to above can be defined in other ways.

The apparent delay from any of these delays can be determined similarly as described in the context of FIG. 6B. For example, the apparent delay T_{B1}′ can be determined as T_{B1}′=T_{B1}−K/2 and the apparent delay T_{C1}′ can be determined as T_{C1}′=T_{C1}−K/2. In another example, the apparent delay T_{B}′ can be determined by the equation T_{B}′=T_{B1}′+T_{B2}′+T_{B3}′, where T_{B1}′=T_{B1}−K/6, T_{B2}′=T_{B2}−K/6, T_{B3}′=T_{B3}−K/6; and the apparent delay T_{C}′ can be determined by the equation T_{C}′=T_{C1}′+T_{C2}′+T_{C3}′, where T_{C1}′=T_{C1}−K/6, T_{C2}′=T_{C2}−K/6, T_{C3}′=T_{C3}−K/6. In these examples, the MU 130 initially increases the loopback processing delay T_{LB} by K as given by the value T_{LB}′=T_{LB}+K, but reports the loopback processing delay as T_{LB} to ‘trick’ the DU 124 to increase the allowable DAS delay as previously described. As previously described, DU 124 determines the apparent delays T_{A}′, T_{D}′ based on the loopback processing delay T_{LB} reported by MU 130, and the MU 130 reports the apparent DAS delay (T_{B}′, T_{C}′) to the DU 124. In response, the DU 124 determines the total downlink/uplink delays T_{DL}′/T_{UL}′ based on the apparent DAS delay and the delays T_{A}′, T_{B}′.

The apparent signal path delay can be reported by various nodes of the distributed antenna system. In some examples, MU 130 is configured to report the apparent signal path delay of one or more signal paths of the distributed antenna system, such as the apparent roundtrip delay T_{RT}′, the apparent DAS downlink delay T_{B}′, and/or the apparent DAS uplink delay T_{C}′. The MU 130 can also be configured to determine the delay variable K based on a maximum allowable delay threshold for a signal propagating through the DAS 100. The MU can then report the apparent signal delay to the DU 124 or other RAN node. In other examples, the determination of the delay variable and the apparent signal path delay(s) are determined by a management system communicatively coupled to the DAS 100 (and its associated nodes). From the perspective of the DU 124 or other RAN node, the signal path delay through the DAS 100 will be the apparent signal path delay reported by the DAS 100 instead of the actual signal path delay.

Although the modification of the signal path delay is described in the context of a distributed antenna system, such techniques can also be applied in other distributed communication systems. For example, the signal path delay modification techniques can be applied between other RAN nodes in the network, or between a first unit and a second unit of a system more generally.

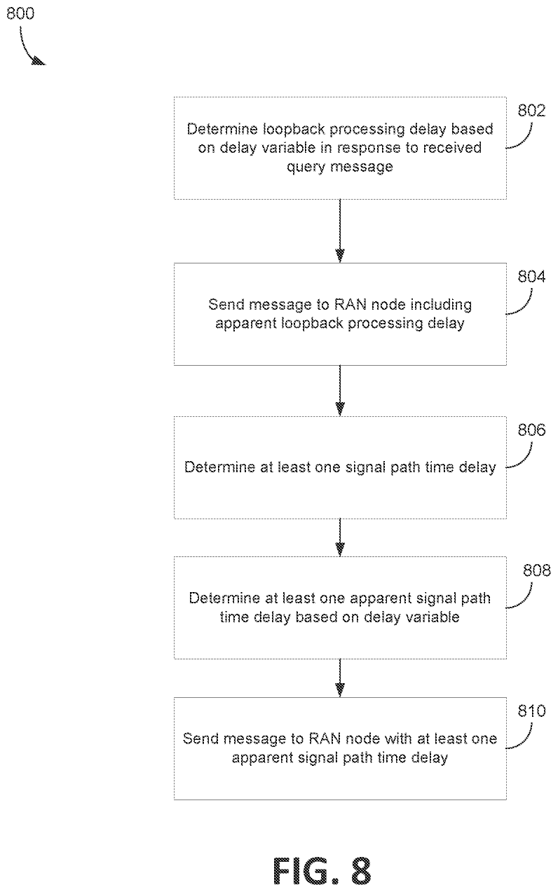

FIG. 8 depicts a flow diagram of a method for compensating excessive time delay due to signal propagation in a system coupled to a RAN. The blocks of the flow diagram have been arranged in a generally sequential manner for ease of explanation; however, it is to be understood that this arrangement is merely exemplary, and it should be recognized that the processing associated with method 800 and the other methods presented herein can occur in a different order, for example, where at least some of the processing associated with the blocks is performed in parallel and/or in an event-driven manner. Also, most standard exception handling is not described for ease of explanation; however, it is to be understood that method 800 and the other methods presented herein can and typically would include such exception handling. Moreover, one or more aspects of method 800 and the other methods presented herein can be configurable or adaptive (either manually or in an automated manner). In some examples, method 800 is performed by MU 130, a management system coupled to the MU 130, or a first unit of a system. Such a first unit includes at least one processor that is configured to perform the functions of method 800.

Method 800 includes determining loopback processing delay based on a delay variable at block 802. The loopback processing delay is determined in response to receiving a query message from the at least one RAN node. For example, DU 124 can send a loopback query message to the MU 130 as part of a loopback messaging protocol. In determining the loopback processing delay, method 800 delays the processing of the query message longer than the minimum time it would usually take to process the query message. The amount of delay increased to the minimum processing delay time is the amount of the delay variable K.

At block 804, method 800 sends a message to the at least one RAN node including an apparent loopback processing delay. The apparent loopback processing delay reported at block 804 is less than the loopback processing delay determined at block 802 and is incurred when processing the query message. In some examples, the apparent loopback processing delay is the delay that would normally have been incurred if the query message had been immediately processed, e.g., the minimum processing time. By sending the message to the at least one RAN node at block 804, method 800 causes the at least one RAN node to determine an apparent delay between at least one signal path between the at least one RAN node and the DAS. The delay is apparent because it is not actually the delay associated with the at least one signal path between the at least one RAN node and the DAS, but rather is the delay that is calculated in reliance on the apparent loopback processing delay reported by the DAS from block 804. In reality, the actual delay associated with the at least one signal path between the at least one RAN node and the DAS is less than the apparent delay that is calculated by the at least one RAN node.

Method 800 further includes determining at least one signal path time delay of one or more signal paths of the system at block 806. In the context of a DAS, the signal path delay can include a path delay associated with the path between a MU, RU, or ICN in the downlink or uplink direction. In some examples, the signal path delay includes the roundtrip delay associated with the time in which a downlink signal propagates from the MU to the RU and the time in which an uplink signal is received by the MU. The signal path delay can be determined between a path that communicatively couples the first unit with the second unit more generally. For example, the signal path can be defined by an I/O port of the first unit to an I/O port of the second unit.

After determining the at least one signal path time delay, method 800 then proceeds to block 808 and determines at least one apparent signal path time delay based on the delay variable. The delay variable used to determine the apparent signal path time delay is the same variable used to determine the apparent loopback processing delay. For example, the at least one apparent signal path time delay can be determined by subtracting the actual signal path time delay calculated at block 806 with the delay variable K. Therefore, the apparent signal path time delay will be less than the signal path time delay calculated at block 806. In the downlink signal path, the apparent downlink path delay for the system can be determined by subtracting the actual downlink path delay for the system with the value K/2, as previously described. The apparent uplink path delay and apparent roundtrip delay can be calculated in a similar manner. The apparent signal path time delay is determined to be a value that is less than a maximum tolerance threshold corresponding to the delay of the signal path. For example, in the DAS case, the apparent DAS roundtrip signal path delay is less than a threshold associated with a maximum roundtrip delay imposed on the DAS.

At block 810, method 800 proceeds by sending a second message to the at least one RAN node including the at least one apparent signal path time delay. Because the at least one RAN node has overestimated the delays between the signal paths between at least one RAN node and the system, the total delay (e.g., the total roundtrip delay) is equal to the apparent delay as perceived by the at least one RAN node. Furthermore, the apparent system delays reported by method 800 to the at least one RAN node appear to satisfy the tolerance delay constraints for signal propagation that are imposed on the system. Therefore, by manipulating the delays reported to the at least one RAN node, the system can still operate normally even when there are additional delays incurred by propagating downlink and uplink signals in the system.

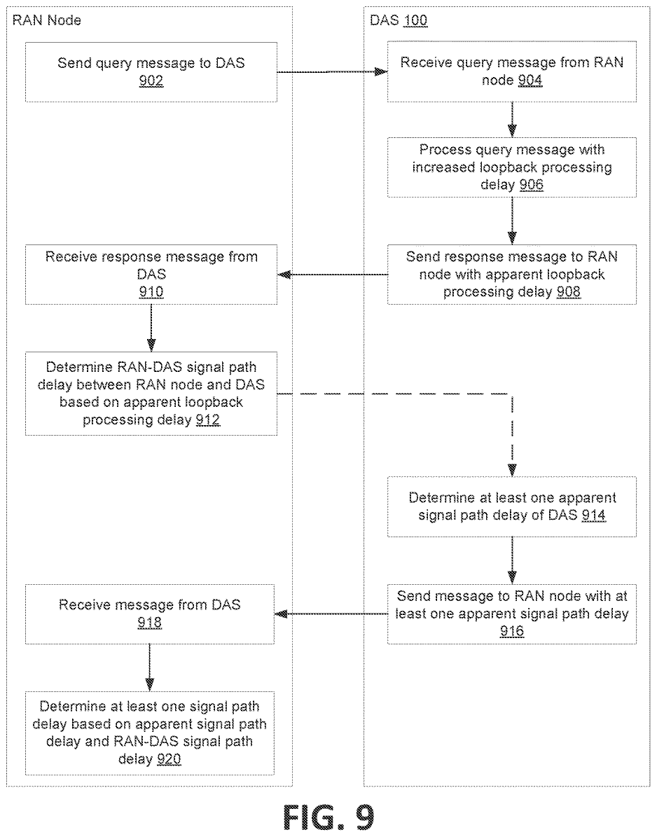

FIG. 9 depicts a flow diagram for compensating excessive time delay due to signal propagation in a DAS. FIG. 9 can be performed in conjunction with the functions described in method 800 and implemented using the description of FIGS. 1-8. Specifically, FIG. 9 depicts an example of the functions described in method 800 when the system is a DAS. In one example, the RAN node is the DU 124 and the functions of DAS 100 are performed by MU 130.

Initially, RAN node sends a query message to a DAS node at block 902 as part of a bidirectional messaging protocol, such as a loopback messaging protocol. DAS 100 receives the query message from the RAN node at block 904 and processes the query message at block 906. However, DAS 100 intentionally increases the time associated with processing the query message by an amount K. After delaying the processing time, DAS 100 sends a response message to the RAN node (incorrectly) reporting the apparent loopback processing delay at block 908. That is, instead of reporting the actual processing time it took to process the query message at block 906, DAS 100 reports a lesser apparent loopback processing delay at block 908. The RAN node receives this response message with the apparent loopback processing delay at block 910.

Based on the (incorrect) information reported by DAS 100, the RAN node at block 912 determines at least one signal path delay that couples the RAN node to the DAS 100. Because the RAN node can determine the total time in which the query message was sent and the response message was received, and the apparent loopback processing delay from the DAS 100, the RAN node calculates the apparent signal path delay(s) between the RAN node and the DAS 100. The resulting signal path delay(s) determined by the RAN node are ‘apparent’ delays because they are in fact longer than the actual signal path delay(s) between the RAN node and the DAS 100.

At some later time (which need not be responsive to the determination of the apparent loopback processing delay(s) from block 912), DAS 100 determines at least one apparent signal path delay of the DAS at block 914. The signal path delay(s) determined by the DAS 100 at block 914 are ‘apparent’ delays because they are in fact shorter than the actual signal path delays corresponding to signal propagation in the DAS. The apparent signal path delay(s) determined by the DAS 100 at block 914 are below a maximum delay threshold. The DAS 100 then sends a message to the RAN node that includes the apparent signal path delay(s) to the RAN node at block 916.

The RAN node receives the apparent signal path delay(s) from the DAS 100 at block 918. From this information, at block 920 the RAN node determines at least one signal path delay based on the apparent signal path delay(s) reported by the DAS 100 and the apparent signal path delay(s) between the RAN node and the DAS calculated from block 912. Using the total downlink signal path delay as an example, since the RAN node uses the apparent signal path delay T_{A}′ calculated at block 912 and receives the apparent DAS downlink signal path delay T_{B}′, the RAN node determines the same total downlink signal path delay as it would have calculated if the RAN node were using the actual signal path delays T_{A} and T_{B}. However, by using the apparent signal path delays, the RAN node perceives that the downlink signal path delay from the DAS 100 is within the maximum delay threshold (even if that is not in fact the case). As a result, the DAS 100 can accommodate some additional delay when propagating downlink and uplink signals in the DAS.

The methods and techniques described herein may be implemented in digital electronic circuitry, or with a programmable processor (for example, a special-purpose processor or a general-purpose processor such as a computer) firmware, software, or in various combinations of each. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instruction to, a data storage system, at least one input device, and at least one output device.

Generally, a processor will receive instructions and data from a read-only memory and/or a random-access memory. Storage devices suitable for tangibly embodying computer program instructions and data include all forms of non-volatile memory, including by way of example semiconductor memory devices, such as erasable programmable read-only memory (EPROM), electrically erasable programmable read-only memory (EEPROM), and flash memory devices; magnetic disks such as internal hard disks and removable disks; magneto-optical disks; and digital video disks (DVDs). Any of the foregoing may be supplemented by, or incorporated in, specially-designed application specific integrated circuits (ASICs).

### Example Embodiments

Example 1 includes a method for compensating excessive time delay due to signal propagation in a distributed antenna system, wherein the distributed antenna system comprises at least one master unit coupled to a plurality of radio units, wherein each radio unit of the plurality of radio units is coupled to at least one antenna, wherein the at least one master unit is coupled to at least one radio access network (RAN) node, the method comprising: determining a loopback processing delay based on a delay variable in response to a received query message from the at least one RAN node; sending a first message to the at least one RAN node including an apparent loopback processing delay, wherein the apparent loopback processing delay is less than the loopback processing delay; determining at least one signal path time delay of one or more signal paths of the distributed antenna system, wherein the at least one signal path time delay corresponds to a period of time in which a signal propagates from one point of the one or more signal paths to a second point of the one or more signal paths; determining at least one apparent signal path time delay of the one or more signal paths based on the delay variable and the respective at least one signal path time delay; and sending a second message to the at least one RAN node that includes the at least one apparent signal path time delay.
Example 2 includes the method of Example 1, wherein the at least one apparent signal path time delay includes an apparent downlink signal path time delay of the distributed antenna system and/or an apparent uplink signal path time delay of the distributed antenna system.
Example 3 includes the method of Example 2, wherein the apparent downlink signal path time delay and the apparent uplink signal path time delay are determined based on an equal value of the delay variable.
Example 4 includes the method of any of Examples 2-3, wherein the apparent downlink signal path time delay is determined by subtracting a downlink signal path time delay with one half of the delay variable, wherein the apparent uplink signal path time delay is determined by subtracting an uplink signal path time delay with one half of the delay variable.
Example 5 includes the method of any of Examples 1-4, wherein the at least one signal path time delay corresponds to a difference in time from when the signal is received at an input/output (I/O) port of the at least one master unit and when the signal is received at an I/O port of a radio unit of the plurality of radio units.
Example 6 includes the method of any of Examples 1-5, wherein the distributed antenna system comprises at least one intermediate combining node (ICN) coupled between the at least one master unit and at least one radio unit of the plurality of radio units, wherein the at least one signal path time delay corresponds to a difference in time from when the signal is received at an input/output (I/O) port of the ICN and at least one of: (1) when the signal is received at an I/O port of the at least one master unit; or (2) when the signal is received at an I/O port of one of the at least one radio unit.
Example 7 includes the method of any of Examples 1-6, wherein the apparent loopback processing delay corresponds to a minimum time period associated with the at least one master unit in processing the query message.
Example 8 includes the method of any of Examples 1-7, wherein the at least one signal path time delay is greater than a threshold value indicative of a maximum tolerance corresponding to the respective at least one signal path time delay, wherein the at least one apparent signal path time delay is less than the threshold value.
Example 9 includes the method of Example 8, wherein by sending the first message to the at least one RAN node, the at least one master unit is configured to cause the at least one RAN node to determine at least one apparent signal path time delay between the at least one RAN node and the at least one master unit, wherein the at least one apparent signal path time delay is greater than a respective at least one actual signal path time delay between the at least one RAN node and the at least one master unit.
Example 10 includes a distributed antenna system, comprising: at least one master unit communicatively coupled to at least one radio access network (RAN) node; and a plurality of radio units communicatively coupled to the at least one master unit, wherein each radio unit of the plurality of radio units is coupled to at least one antenna; wherein the at least one master unit is configured to determine a loopback processing delay based on a delay variable in response to a received query message from the at least one RAN node; wherein the at least one master unit is configured to send a first message to the at least one RAN node including an apparent loopback processing delay, wherein the apparent loopback processing delay is less than the loopback processing delay; wherein the at least one master unit is configured to determine at least one signal path time delay of one or more signal paths of the distributed antenna system, wherein the at least one signal path time delay corresponds to a period of time in which a signal propagates from one point of the one or more signal paths to a second point of the one or more signal paths; wherein the at least one master unit is configured to determine at least one apparent signal path time delay of the one or more signal paths based on the delay variable and the respective at least one signal path time delay; wherein the at least one master unit is configured to send a second message to the at least one RAN node that includes the at least one apparent signal path time delay.
Example 11 includes the distributed antenna system of Example 10, wherein the at least one RAN node comprises a distributed unit (DU).
Example 12 includes the distributed antenna system of any of Examples 10-11, wherein the at least one apparent signal path time delay includes an apparent downlink signal path time delay of the distributed antenna system and/or an apparent uplink signal path time delay of the distributed antenna system.
Example 13 includes the distributed antenna system of Example 12, wherein the apparent downlink signal path time delay and the apparent uplink signal path time delay are determined based on an equal value of the delay variable.
Example 14 includes the distributed antenna system of any of Examples 12-13, wherein the apparent downlink signal path time delay is determined by subtracting a downlink signal path time delay with one half of the delay variable, wherein the apparent uplink signal path time delay is determined by subtracting an uplink signal path time delay with one half of the delay variable.
Example 15 includes the distributed antenna system of any of Examples 10-14, wherein the at least one signal path time delay corresponds to a difference in time from when the signal is received at an input/output (I/O) port of the at least one master unit and when the signal is received at an I/O port of a radio unit of the plurality of radio units.
Example 16 includes the distributed antenna system of any of Examples 10-15, wherein the distributed antenna system comprises at least one intermediate combining node (ICN) coupled between the at least one master unit and at least one radio unit of the plurality of radio units, wherein the at least one signal path time delay corresponds to a difference in time from when the signal is received at an input/output (I/O) port of the ICN and at least one of: (1) when the signal is received at an I/O port of the at least one master unit; or (2) when the signal is received at an I/O port of one of the at least one radio unit.
Example 17 includes the distributed antenna system of any of Examples 10-16, wherein the apparent loopback processing delay corresponds to a minimum time period associated with the at least one master unit in processing the query message.
Example 18 includes the distributed antenna system of any of Examples 10-17, wherein the at least one signal path time delay is greater than a threshold value indicative of a maximum tolerance corresponding to the respective at least one signal path time delay, wherein the at least one apparent signal path time delay is less than the threshold value.
Example 19 includes a system, comprising: at least one first unit communicatively coupled to at least one radio access network (RAN) node; and a plurality of second units communicatively coupled to the at least one first unit via one or more signal paths, wherein the at least one first unit comprises at least one processor, wherein the at least one processor is configured to: determine a loopback processing delay based on a delay variable in response to a received query message from the at least one RAN node, send a first message to the at least one RAN node including an apparent loopback processing delay, wherein the apparent loopback processing delay is less than the loopback processing delay, determine at least one signal path time delay of the one or more signal paths, wherein the at least one signal path time delay corresponds to a period of time in which a signal propagates from one point of the one or more signal paths to a second point of the one or more signal paths; determine at least one apparent signal path time delay of the one or more signal paths based on the delay variable; send a second message to the at least one RAN node that includes the at least one apparent signal path time delay.
Example 20 includes the system of Example 19, wherein by sending the first message to the at least one RAN node, the at least one first unit is configured to cause the at least one RAN node to determine at least one apparent signal path time delay between the at least one RAN node and the at least one first unit, wherein the at least one apparent signal path time delay is greater than a respective at least one actual signal path time delay between the at least one RAN node and the at least one first unit.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A method for compensating excessive time delay due to signal propagation in a distributed antenna system, wherein the distributed antenna system comprises at least one master unit coupled to a plurality of radio units, wherein each radio unit of the plurality of radio units is coupled to at least one antenna, wherein the at least one master unit is coupled to at least one radio access network (RAN) node, the method comprising:
determining a loopback processing delay based on a delay variable in response to a received query message from the at least one RAN node;
sending a first message to the at least one RAN node including an apparent loopback processing delay, wherein the apparent loopback processing delay is less than the loopback processing delay;
determining at least one signal path time delay of one or more signal paths of the distributed antenna system, wherein the at least one signal path time delay corresponds to a period of time in which a signal propagates from one point of the one or more signal paths to a second point of the one or more signal paths;
determining at least one apparent signal path time delay of the one or more signal paths based on the delay variable and the respective at least one signal path time delay; and
sending a second message to the at least one RAN node that includes the at least one apparent signal path time delay.

2. The method of claim 1, wherein the at least one apparent signal path time delay includes an apparent downlink signal path time delay of the distributed antenna system and/or an apparent uplink signal path time delay of the distributed antenna system.

3. The method of claim 2, wherein the apparent downlink signal path time delay and the apparent uplink signal path time delay are determined based on an equal value of the delay variable.

4. The method of claim 2, wherein the apparent downlink signal path time delay is determined by subtracting a downlink signal path time delay with one half of the delay variable, wherein the apparent uplink signal path time delay is determined by subtracting an uplink signal path time delay with one half of the delay variable.

5. The method of claim 1, wherein the at least one signal path time delay corresponds to a difference in time from when the signal is received at an input/output (I/O) port of the at least one master unit and when the signal is received at an I/O port of a radio unit of the plurality of radio units.

6. The method of claim 1, wherein the distributed antenna system comprises at least one intermediate combining node (ICN) coupled between the at least one master unit and at least one radio unit of the plurality of radio units, wherein the at least one signal path time delay corresponds to a difference in time from when the signal is received at an input/output (I/O) port of the ICN and at least one of: (1) when the signal is received at an I/O port of the at least one master unit; or (2) when the signal is received at an I/O port of one of the at least one radio unit.

7. The method of claim 1, wherein the apparent loopback processing delay corresponds to a minimum time period associated with the at least one master unit in processing the query message.

8. The method of claim 1, wherein the at least one signal path time delay is greater than a threshold value indicative of a maximum tolerance corresponding to the respective at least one signal path time delay, wherein the at least one apparent signal path time delay is less than the threshold value.

9. The method of claim 8, wherein by sending the first message to the at least one RAN node, the at least one master unit is configured to cause the at least one RAN node to determine at least one apparent signal path time delay between the at least one RAN node and the at least one master unit, wherein the at least one apparent signal path time delay is greater than a respective at least one actual signal path time delay between the at least one RAN node and the at least one master unit 10. A distributed antenna system, comprising:
at least one master unit communicatively coupled to at least one radio access network (RAN) node; and
a plurality of radio units communicatively coupled to the at least one master unit, wherein each radio unit of the plurality of radio units is coupled to at least one antenna;
wherein the at least one master unit is configured to determine a loopback processing delay based on a delay variable in response to a received query message from the at least one RAN node;
wherein the at least one master unit is configured to send a first message to the at least one RAN node including an apparent loopback processing delay, wherein the apparent loopback processing delay is less than the loopback processing delay;
wherein the at least one master unit is configured to determine at least one signal path time delay of one or more signal paths of the distributed antenna system, wherein the at least one signal path time delay corresponds to a period of time in which a signal propagates from one point of the one or more signal paths to a second point of the one or more signal paths;
wherein the at least one master unit is configured to determine at least one apparent signal path time delay of the one or more signal paths based on the delay variable and the respective at least one signal path time delay;
wherein the at least one master unit is configured to send a second message to the at least one RAN node that includes the at least one apparent signal path time delay.

11. The distributed antenna system of claim 10, wherein the at least one RAN node comprises a distributed unit (DU).

12. The distributed antenna system of claim 10, wherein the at least one apparent signal path time delay includes an apparent downlink signal path time delay of the distributed antenna system and/or an apparent uplink signal path time delay of the distributed antenna system.

13. The distributed antenna system of claim 12, wherein the apparent downlink signal path time delay and the apparent uplink signal path time delay are determined based on an equal value of the delay variable.

14. The distributed antenna system of claim 12, wherein the apparent downlink signal path time delay is determined by subtracting a downlink signal path time delay with one half of the delay variable, wherein the apparent uplink signal path time delay is determined by subtracting an uplink signal path time delay with one half of the delay variable.

15. The distributed antenna system of claim 10, wherein the at least one signal path time delay corresponds to a difference in time from when the signal is received at an input/output (I/O) port of the at least one master unit and when the signal is received at an I/O port of a radio unit of the plurality of radio units.

16. The distributed antenna system of claim 10, wherein the distributed antenna system comprises at least one intermediate combining node (ICN) coupled between the at least one master unit and at least one radio unit of the plurality of radio units, wherein the at least one signal path time delay corresponds to a difference in time from when the signal is received at an input/output (I/O) port of the ICN and at least one of: (1) when the signal is received at an I/O port of the at least one master unit; or (2) when the signal is received at an I/O port of one of the at least one radio unit.

17. The distributed antenna system of claim 10, wherein the apparent loopback processing delay corresponds to a minimum time period associated with the at least one master unit in processing the query message.

18. The distributed antenna system of claim 10, wherein the at least one signal path time delay is greater than a threshold value indicative of a maximum tolerance corresponding to the respective at least one signal path time delay, wherein the at least one apparent signal path time delay is less than the threshold value.

19. A system, comprising:
at least one first unit communicatively coupled to at least one radio access network (RAN) node; and
a plurality of second units communicatively coupled to the at least one first unit via one or more signal paths,
wherein the at least one first unit comprises at least one processor, wherein the at least one processor is configured to:
determine a loopback processing delay based on a delay variable in response to a received query message from the at least one RAN node,
send a first message to the at least one RAN node including an apparent loopback processing delay, wherein the apparent loopback processing delay is less than the loopback processing delay,
determine at least one signal path time delay of the one or more signal paths, wherein the at least one signal path time delay corresponds to a period of time in which a signal propagates from one point of the one or more signal paths to a second point of the one or more signal paths;
determine at least one apparent signal path time delay of the one or more signal paths based on the delay variable;
send a second message to the at least one RAN node that includes the at least one apparent signal path time delay.

20. The system of claim 19, wherein by sending the first message to the at least one RAN node, the at least one first unit is configured to cause the at least one RAN node to determine at least one apparent signal path time delay between the at least one RAN node and the at least one first unit, wherein the at least one apparent signal path time delay is greater than a respective at least one actual signal path time delay between the at least one RAN node and the at least one first unit.
